(19) United States
(12) Patent Application Publication
(10) Pub. No.: US 2006/0137175 A1
(43) Pub. Date: Jun. 29, 2006

(54) Method for manufacturing battery

(75) Inventors: Takayuki Hayashi, Kosai-shi (JP); Yoshihiro Bouki, Fujisawa-shi (JP); Mitsugu Takaki, Toyohashi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha

(21) Appl. No.: 11/302,270

(22) Filed: Dec. 14, 2005

(30) Foreign Application Priority Data
Dec. 24, 2004 (JP) 2004-374171

(51) Int. Cl. H01M 10/04

(52) U.S. Cl. 29/623.1

(57) ABSTRACT

An alkaline secondary battery has a positive electrode plate having a predetermined shape, formed from a long-shaped electrode substrate. A manufacturing method thereof comprises an impurity detecting step for applying X-rays to the electrode substrate to acquire a transmitted image, and detecting based on the transmitted image whether a metal impurity particle made of a metal dissolved at a positive electrode potential and deposited at a negative electrode potential exists in the electrode substrate. The method includes a marking step for, when the metal impurity particle exists, applying a marking indicative of its particle-existing portion on the electrode substrate.

### BACKGROUND OF THE INVENTION

1. Field of the Invention

The present invention relates to a method for manufacturing a battery having an electrode plate of a predetermined shape formed from an electrode substrate, and to a method for manufacturing an electrode substrate used in such a battery. The present invention relates particularly to a method for manufacturing a battery, comprising an impurity detecting step for detecting the existence of an impurity particle and to a method for manufacturing an electrode substrate, which includes an impurity detecting step for detecting the existence of an impurity particle.

2. Description of Related Art

It has heretofore been known to, for the purpose of enhancing battery's reliability, perform an inspection for examining a completed battery and examining in the process of manufacturing a battery whether or not the battery and its parts are defective.

There is known, for example, a destructive impurity inspection test for examining the existence of mixing of impurities that will cause defective conditions in a battery by dissolving the battery or its parts in the course of their manufacture.

There is also known a reliability evaluation test which places a battery in an acceleration evaluable environment and evaluates the performance of the battery. A testing method of this sort has been disclosed in, for example, Japanese unexamined patent application publication No. 2002-6012 (refer to claims and others) and Japanese unexamined patent application publication No. 2003-77527 (refer to claims and others).

There is further known a method for examining, using X-rays, the existence of cracking and chipping, positional displacements or the like of positive and negative electrodes in an electrode group, and failures in shape and form, which occur in battery parts in the course of their manufacture. An inspection method of this sort has been disclosed in, for example, Japanese unexamined patent application publication No. H8(1996)-50900 (refer to claims and others) and Japanese unexamined patent application publication No. 2004-22206 (refer to claims and others).

### SUMMARY OF THE INVENTION

Since it is however necessary to dissolve (destroy) the samples, the destructive impurity inspection test is capable of merely performing a sampling inspection and cannot assure all the manufactured batteries as non-defective units.

The evaluation test in the acceleration environment has a fear that since evaluation cannot be carried out without the completion of construction of a battery even though defective units exist in battery parts in the process of manufacture, the cost of production will increase.

The conventional inspection method using the X-rays is capable of basically merely discriminating the failures in shape and form of each battery part. Therefore, the inspection method is accompanied by a problem that when an impurity is contained inside each part, for example, it cannot be eliminated as a defective unit. Particularly if a metal impurity particle made of a metal to be dissolved at a positive electrode potential and deposited at a negative electrode potential is mixed into or adhered onto an electrode substrate or a positive electrode plate, the metal impurity particle is dissolved from the positive electrode plate while the assembled battery is repeatedly charged and discharged. On the other hand, the metal impurity is deposited and grown on the negative electrode plate. Thus, there is a fear that a small short circuit will occur between the positive electrode plate and the negative electrode plate.

The present invention has been made in view of such a problem. Objects of the present invention are to provide a battery manufacturing method capable of inspecting in a manufacturing process whether a metal impurity particle that will cause a short circuit in a battery exists in electrode plates or positive electrode plates, and an electrode substrate manufacturing method.

To solve the above problems, according to the invention, there is provided a method for manufacturing a battery having a positive electrode plate having a predetermined shape, formed from an electrode substrate, comprising: an impurity detecting step for applying X-rays onto the electrode substrate or the positive electrode plate corresponding to an object to be examined to acquire a transmitted image, and detecting based on the transmitted image whether a metal impurity particle comprising a metal to be dissolved at a positive electrode potential and deposited at a negative electrode potential exists in the object.

If the metal impurity particle made of the metal to be dissolved at the positive electrode potential and deposited at the negative electrode potential exists in the electrode substrate or the positive electrode plate as mentioned above, there is a fear that a short circuit occurs between the positive electrode plate and its corresponding negative electrode plate in the manufactured battery. Particularly when the metal impurity particle is exposed at the surface of the electrode substrate, there is a fear that a short circuit occurs due to the metal impurity particle. Further, there is a fear that even in a state in which the metal impurity particle is buried inside the electrode substrate, a short circuit occurs in like manner when the metal impurity particle is exposed at the surface of the electrode substrate where the electrode substrate is compressed by a compression roll or cut.

In contrast, the manufacturing method of the present invention includes the impurity detecting step for applying X-rays to an electrode substrate or a positive electrode plate to acquire a transmitted image and detecting based on the transmitted image whether the metal impurity particle exists in the electrode substrate or the positive electrode plate. Since the existence of the metal impurity particle in the surface or inside of the electrode substrate or the positive electrode plate can be confirmed owing to the addition of such a step, a high-reliability battery capable of easily eliminating defective parts and hard to cause a short circuit can be manufactured. Since this step is done in the process of manufacturing the battery, it enables elimination of defective parts at a stage prior to the construction of the battery, and can contribute even to a reduction in production cost.

Here, the term “electrode substrate” is not limited by its quality of material and form or the like in particular and may be one used in general. In the case of an alkaline secondary battery, for example, electrode substrates such as foamed nickel and a nickel-plated steel plate or the like are used as positive core materials or members. In the present specification, the electrode substrate contains not only one comprised of a core material or member but also one placed in a state in which a core member is formed with a positive active substance layer.

The term “positive electrode plates” are not particularly limited by their forms and the quality of a positive active substance or the like if they are equivalent to ones obtained by processing an electrode substrate bearing a positive active substance into predetermined shapes.

As the “metal to be dissolved at the positive electrode potential and deposited at the negative electrode potential”, may be mentioned, for example, Cu, Pb, Ag, Sn, etc. When Cu is especially deposited at its corresponding negative electrode plate, it results in dendrite or filaments and is grown toward the positive electrode plate and hence a short circuit is apt to occur. Therefore, the existence of a metal impurity particle made of Cu may preferably be detected more reliably.

An object to be examined in the impurity detecting step may be either the electrode substrate or the positive electrode plates as described above. Since, however, the positive electrode plate is processed into a predetermined shape, whereas the electrode substrate is generally shaped in the form of a strip (long-shaped), the treatment of the electrode substrate as the object to be examined is suitable because the impurity detecting step can be performed continuously.

Furthermore, in the above battery manufacturing method, preferably, the impurity detecting step is performed using an X-ray fluoroscopic inspection apparatus capable of detecting the presence or absence of the metal impurity particle whose particle diameter is 150 μm or more.

When the diameter of the metal impurity particle that exists in the electrode substrate or the positive electrode plate is greater than or equal to 150 μm, there is a high possibility that a short circuit will occur between the positive electrode plate and the negative electrode plate in the manufactured battery.

In the battery manufacturing method of the present invention in contrast, the impurity detecting step is performed using an X-ray fluoroscopic inspection apparatus capable of detecting the presence or absence of the metal impurity particle whose particle diameter is 150 μm or more. It is thus possible to more reliably eliminate the electrode substrate and the positive electrode plate both having high danger of causing short circuit.

In the present invention, the X-ray fluoroscopic inspection apparatus may be one capable of detecting whether a metal impurity particle whose particle diameter is 150 μm or more exists. It is however preferable to use an X-ray fluoroscopic inspection apparatus having an X-ray image intensifier large in dynamic range.

Furthermore, in the above battery manufacturing method, preferably, the impurity detecting step displays the transmitted image as a color image by using an X-ray fluoroscopic inspection apparatus having a color X-ray image intensifier and detects the presence or absence of the metal impurity particle.

In an X-ray fluoroscopic inspection apparatus having a monochrome image intensifier, its transmitted image has only one characteristic curve as a black-to-white density.

In contrast, an X-ray fluoroscopic inspection apparatus having a color X-ray image intensifier is used in the present invention. This allows images to have three characteristic curves as respective densities of primary colors R (red component), G (green component) and B (blue component). Therefore, they have characteristics different every R, G and B components and can simultaneously be displayed according to color coding. Therefore, a dynamic range for measurement is enlarged as compared with the monochrome and the accuracy of inspection is improved. It is thus possible to more reliably eliminate defective parts in each of which a metal impurity particle whose particle diameter is 150 μm or more exists.

Furthermore, in the above battery manufacturing method, preferably, the impurity detecting step treats the electrode substrate as the object, and the method further comprises a marking step for, when the existence of the metal impurity particle in the electrode substrate is detected in the impurity detecting step, applying a marking indicative of a particle-existing portion on the electrode substrate.

When a defective unit is found where the object examined in the impurity detecting step is positive electrode plates, it may be eliminated immediately after its detection. However, there may be cases in which when the object examined is of an electrode substrate, it is often difficult to eliminate a defective portion immediately after the impurity detecting step for convenience in production line.

In contrast, the battery manufacturing method of the present invention includes a marking step for, when the existence of a metal impurity particle in an electrode substrate is detected, applying a marking indicative of its particle-existing portion (defective portion) onto the electrode substrate. If such a marking is done, it is possible to easily discriminate which portion of the electrode substrate is a particle-existing portion, even in a subsequent step. Therefore, the particle-existing portion can be eliminated in a step most convenient for production.

Incidentally, the “marking” is not limited in method in particular if it is possible to discriminate in the subsequent step in which portion of the electrode substrate the particle-existing portion exists. It may also be feasible to, for example, providing marking by punching a hole in the neighborhood of a particle-existing portion or by coloring up the neighborhood of the particle-existing portion with ink or the like.

Furthermore, in the above battery manufacturing method, preferably, the impurity detecting step superimposes a plurality of the objects on one another and detects the presence or absence of the metal impurity particle simultaneously with respect to the plural sheets of objects.

In order to confirm the existence of a metal impurity particle by X-rays, much time is generally required as compared with other processing steps. It is therefore desired that the time necessary for the impurity detecting step is shortened.

In the battery manufacturing method of the present invention in contrast, a plurality of sheets of electrode substrates or positive electrode plates are superimposed on one another and the presence or absence of a metal impurity particle is detected simultaneously with respect to the plural sheets. An impurity detecting step of the present invention acquires a transmitted image of X-rays and confirms the presence or absence of the metal impurity particle. Therefore, inspection can also be carried out in a state in which the plurality of sheets of the electrode substrates or the positive electrode plates are being superimposed on one another in this way. If the plural sheets are simultaneously inspected in this way, then the impurity detecting step can be completed in a short period of time correspondingly and hence productivity can be improved.

Incidentally, the number of sheets for simultaneously inspecting the superimposed electrode substrates or positive electrode plates may suitably be changed in consideration of the thicknesses thereof, the ability to detect the metal impurity particle, etc. The number of sheets may preferably be about two to five.

Furthermore, in the above battery manufacturing method, preferably, the impurity detecting step treats the electrode substrate as the object and is performed with a plurality of sheets of the electrode substrates superimposed on one another, and the method further comprises: a marking step for, when the existence of the metal impurity particle is detected at any of the electrode substrates superimposed on one another in the plural sheets in the impurity detecting step, applying a marking indicative of a particle-existing portion on at least any of the electrode substrates; and an eliminating step for eliminating the corresponding portions with respect to the plurality of sheets of electrode substrates based on the marking without confirming in which of the plurality of superimposed electrode substrates the metal impurity particle exists.

When the plurality of sheets of electrode substrates are simultaneously inspected in piles, the impurity detecting step of the present invention is not capable of discriminating in which one of the electrode substrates the metal impurity particle exists. In such a case, there is further considered a method for inspecting the corresponding portion for each sheet to confirm an electrode substrate in which a metal impurity particle exists. Since, however, the further reexamination of the electrode substrates one sheet by one sheet requires a considerable time, it is undesirable in view of production efficiency.

In contrast, the battery manufacturing method of the present invention includes an eliminating step for eliminating the corresponding portions with respect to all of the plurality of sheets of electrode substrates, based on markings without confirming in which one of the simultaneously-inspected plural sheets of electrode substrates the metal impurity particle exists. Thus, when the electrode substrates are simultaneously inspected in plural sheets and the metal impurity particle is found to exist in any of the electrode substrates, the corresponding portions, i.e., its particle-existing portion and portions of other electrode substrates, which overlap with the particle-existing portion, are all eliminated. Because the currently-manufactured electrode substrates are not so increased in the rate of existence of a metal impurity particle at which a short circuit occurs when the battery is constructed. Further, metal impurity particles detected in the impurity detecting step are few in number. On the other hand, when the corresponding portion is further reexamined for each sheet and an examination is made as to in which electrode substrate the metal impurity particle exists, the cost of production is entailed. As in the present invention rather, the elimination of all the corresponding portions of the plurality of sheets of electrode substrates without confirming in which one of the simultaneously-examined plural sheets of electrode substrates the metal impurity particle exists, makes it possible to reduce the cost of production as a whole.

According to another aspect of the invention, there is provided a method for manufacturing an electrode substrate to be used as a positive electrode plate of a battery, comprising: an impurity detecting step for applying X-rays onto the electrode substrate to acquire a transmitted image and detecting based on the transmitted image whether a metal impurity particle comprised of a metal to be dissolved at a positive electrode potential and deposited at a negative electrode potential when the battery is constructed, exists in the electrode substrate.

The battery manufacturing method of the present invention includes an impurity detecting step for applying X-rays to an electrode substrate to acquire a transmitted image and detecting the presence or absence of a metal impurity particle based on the transmitted image. Since the existence of the metal impurity particle in the surface of the electrode substrate or therein can be confirmed owing to the addition of such a step, defective units can easily be eliminated. Thus, if the electrode substrate is utilized, then a high-reliability battery hard to cause a short circuit can be manufactured. There is no need to inspect the presence or absence of the metal impurity particle after the manufacture of the battery. Hence the productivity of the battery is enhanced.

Furthermore, in the above battery manufacturing method, preferably, the impurity detecting step is performed using an X-ray fluoroscopic inspection apparatus capable of detecting the presence or absence of the metal impurity particle whose particle diameter is 150 μm or more.

The battery manufacturing method of the present invention performs an impurity detecting step using an X-ray fluoroscopic inspection apparatus capable of detecting whether a metal impurity particle whose particle diameter is 150 μm or more exists. It is thus possible to more reliably eliminate an electrode substrate having high danger of causing a short circuit when the battery is fabricated.

Furthermore, in the above battery manufacturing method, preferably, the impurity detecting step displays the transmitted image as a color image by using an X-ray fluoroscopic inspection apparatus having a color X-ray image intensifier and detects the presence or absence of the metal impurity particle.

In the battery manufacturing method of the present invention, the transmitted image is displayed as a color image using the X-ray fluoroscopic inspection apparatus having a color X-ray image intensifier in the impurity detecting step. Therefore, a dynamic range for measurement is enlarged as compared with a monochrome, and the accuracy of inspection is improved. It is thus possible to more reliably eliminate a defective part in which a metal impurity particle having a particle diameter of 150 μm or more exists.

Furthermore, in the above battery manufacturing method, preferably, the impurity detecting step superimposes a plurality of sheets of the electrode substrates on one another and detects the presence or absence of the metal impurity particle simultaneously with respect to the plural sheets of electrode substrates.

In the battery manufacturing method of the present invention, a plurality of sheets of electrode substrates are superimposed on one another and the presence or absence of a metal impurity particle is detected simultaneously with respect to the plural sheets in the impurity detecting step. If the plurality of sheets of electrode substrates are inspected simultaneously, then the impurity detecting step can be completed in a short period of time correspondingly, and hence productivity can be enhanced.

Furthermore, it is preferable that the above battery manufacturing method further comprises a marking step for, when the existence of the metal impurity particle in the electrode substrate is detected in the impurity detecting step, applying a marking indicative of a particle-existing portion on the electrode substrate.

The battery manufacturing method of the present invention includes a marking step for, when the existence of a metal impurity particle in an electrode substrate is detected, applying a marking indicative of its particle-existing portion to the electrode substrate. If this marking is done, it is possible to easily discriminate to which portion of the electrode substrate the particle-existing portion (defective portion) corresponds, upon fabrication of the battery later. Thus, suitable adaptation such as elimination of the particle-existing portion in a suitable process step of a battery production process is enabled.

### BRIEF DESCRIPTION OF THE DRAWINGS

FIG. 1 is an explanatory view showing an alkaline secondary battery according to an embodiment;

FIG. 2 is an explanatory view illustrating an impurity detecting step and a marking step in a process for manufacturing the alkaline secondary battery (electrode substrate) according to the embodiment;

FIG. 3 is an explanatory view showing the manner in which in the impurity detecting step, X-rays emitted from an X-ray source enter a color X-ray image intensifier and are outputted as a video signal in a method for manufacturing the alkaline secondary battery (electrode substrate) according to the embodiment;

FIG. 4 is a graph showing an X-ray dosage measured at a position indicated by a broken line A in FIG. 3 in the manufacturing method of the alkaline secondary battery (electrode substrate) according to the embodiment;

FIG. 5 is a graph showing an X-ray dosage measured at a position indicated by a broken line B in FIG. 3 in the manufacturing method of the alkaline secondary battery (electrode substrate) according to the embodiment;

FIG. 6 is a graph showing electron quantity measured at a position indicated by a broken line C in FIG. 3 in the manufacturing method of the alkaline secondary battery (electrode substrate) according to the embodiment;

FIG. 7 is a graph showing light quantity measured at a position indicated by a broken line D in FIG. 3 in the manufacturing method of the alkaline secondary battery (electrode substrate) according to the embodiment;

FIG. 8 is a graph showing a video signal (E) measured in FIG. 3 in the manufacturing method of the alkaline secondary battery (electrode substrate) according to the embodiment;

FIG. 9 is an explanatory view showing the manner in which a metal impurity particle of Cu on the order of 250 μm exists in the electrode substrate in the manufacturing method of the alkaline secondary battery (electrode substrate) according to the embodiment;

FIG. 10 is a graph showing signal strength where the metal impurity particle of Cu on the order of 250 μm exists in the electrode substrate in the manufacturing method of the alkaline secondary battery (electrode substrate) according to the embodiment;

FIG. 11 is an explanatory view showing the manner in which a metal impurity particle of Cu on the order of 150 μm exists in the electrode substrate in the manufacturing method of the alkaline secondary battery (electrode substrate) according to the embodiment;

FIG. 12 is a graph showing signal strength where the metal impurity particle of Cu on the order of 150 μm exists in the electrode substrate in the manufacturing method of the alkaline secondary battery (electrode substrate) according to the embodiment;

FIG. 13 is an explanatory view showing the manner in which metal impurity particle of Cu on the order of 100 μm exists in the electrode substrate in the manufacturing method of the alkaline secondary battery (electrode substrate) according to the embodiment; and

FIG. 14 is a graph showing signal strength where the metal-impurity particle of Cu on the order of 100 μm exists in the electrode substrate in the manufacturing method of the alkaline secondary battery (electrode substrate) according to the embodiment.

### DETAILED DESCRIPTION OF THE PREFERRED EMBODIMENTS

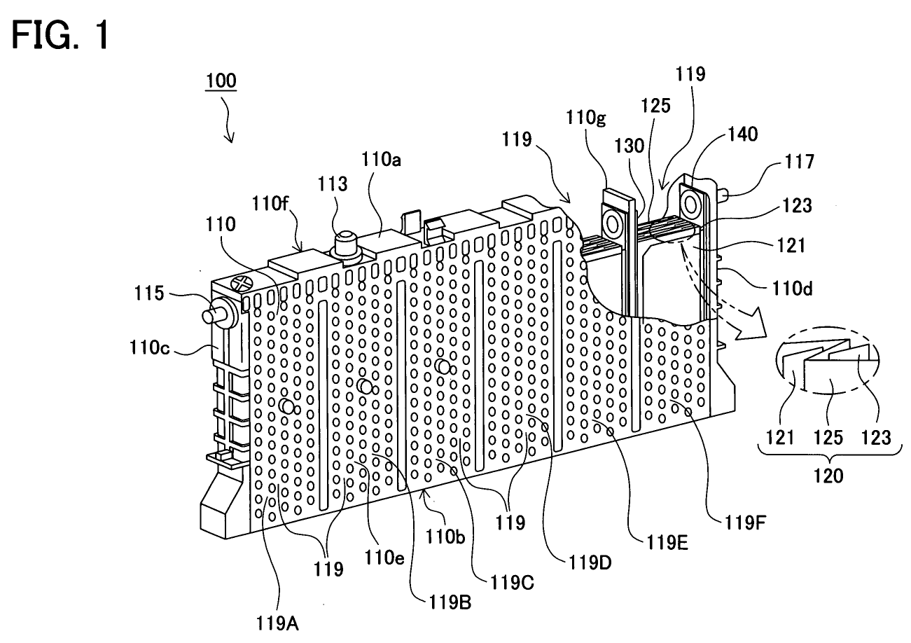

Preferred embodiments of the present invention will hereinafter be described with reference to the accompanying drawings. FIG. 1 shows an alkaline secondary battery 100 according to the present embodiment. The alkaline secondary battery 100 is a nickel hydride battery used as a power supply for an electric vehicle and a hybrid car. It is a rectangular battery shaped substantially in the form of rectangular parallelepiped. The alkaline secondary battery 100 comprises a battery case 110 shaped substantially in the form of rectangular parallelepiped, a plurality of power generating elements 120 accommodated inside the battery case 110, an external positive terminal 115 and an external negative terminal 117 provided fixedly to the battery case 110, etc. The battery case 110 is filled with an electrolytic solution injected therein.

The battery case 110 includes a case top surface 110a (an upper side in FIG. 1) having a substantially rectangular shape in section, a case bottom surface 110b (a lower side as not shown in FIG. 1) substantially parallel to the case top surface 110a, a first case side wall 110c (a left front side in FIG. 1) and a second case side wall 110d (a right back side in FIG. 1) which respectively connect short sides of the case upper surface 110a and short sides of the case lower surface 110b, and a third case side wall 110e (a front side in FIG. 1) and a fourth case side wall 110f (a back side as not shown in FIG. 1) which respectively connect long sides of the case upper surface 110a and long sides of the case lower surface 110b. The battery case 110 has five case partition walls 110g which are substantially parallel to the first and second case side walls 110c and 110d and divide the interior of the battery case 110 into six substantially uniformly.

A safety valve 113 for preventing breakage of the alkaline secondary battery 100 when its internal pressure abnormally rises is provided fixedly to a predetermined position of the case upper surface 110a. The external positive terminal 115 having such a shape as to protrude in a substantially cylindrical form and used for connection to the outside is provided fixedly to a predetermined position of the first case side wall 110c. The external negative terminal 117 having such a shape as to extend out in a substantially cylindrical form and used for connection to the outside is provided fixedly to a predetermined position of the second case side wall 110d.

The alkaline secondary battery 100 is divided into six cells 119 (119A through 119F) by the case partition walls 110g. The power generating elements 120 are accommodated in the cells 119 respectively. The power generating element 120 is constructed by alternately laminating a plurality of positive electrode plates 121 and a plurality of negative electrode plates 123 with porous separators 125 interposed one each therebetween. Both the positive electrode plates 121 and the negative electrode plates 123 are in contact with the electrolytic solution injected in the battery case 110.

The positive electrode plate 121 is structured in a predetermined shape in which an electrode substrate with foamed Ni as a core member is formed with a positive active substance layer (not shown). The negative electrode plate 123 is structured in a predetermined shape in which an electrode substrate with a Ni-plated steel plate as a core member is formed with a negative active substance layer (not shown). The separator 125 is constituted of a sulfonated polypropylene separator. The electrolytic solution is composed of an alkaline solution with potassium hydroxide as a principal solute.

A positive electrode collecting plate 130 and a negative electrode collecting plate 140 each made of a conductive material (nickel-plated steel plate) and substantially rectangular plate-shaped are fixedly provided within each cell 119. Described specifically, the positive electrode collecting plate 130 is disposed parallel to the case partition wall 110g and disposed in the cell 119 on the external positive terminal 115 side (a left front side in FIG. 1). The negative electrode collecting plate 140 is disposed parallel to the case partition wall 110g and disposed in the cell 119 on the external negative terminal 117 side (a right back side in FIG. 1). The positive electrode collecting plate 130 (not shown) of the cell 119A (the left front side in FIG. 1) located on the outermost positive terminal 115 side is electrically connected to its corresponding external positive terminal 115 by being welded to the external positive terminal 115 that extends through the first case side wall 110c. The negative electrode collecting plate 130 of the cell 119F (the right back side in FIG. 1) located on the outermost negative terminal 117 side is electrically connected to its corresponding external negative terminal 117 by being welded to the external negative terminal 117 that extends through the second case side wall 110d. On the other hand, the positive electrode collecting plates 130 and negative electrode collecting plates 140 other than the above ones are respectively electrically connected by welding through connecting members (not shown) that extend through the case partition walls 110g.

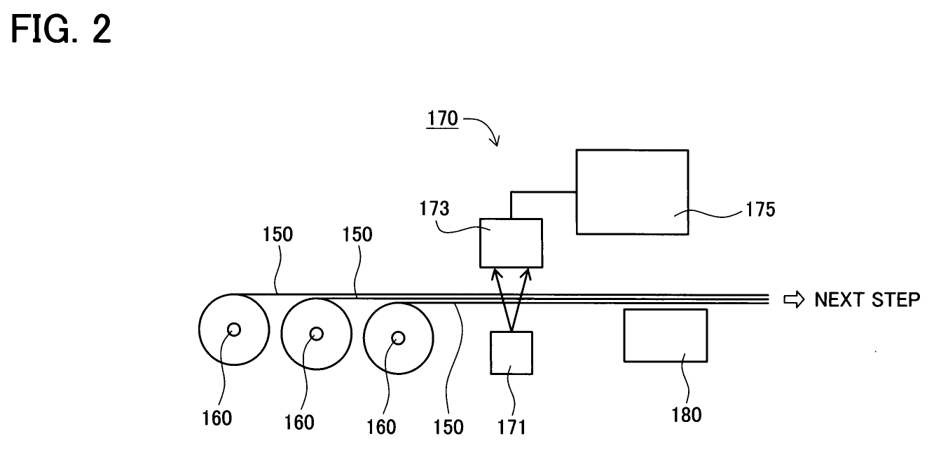

The above alkaline secondary battery 100 is manufactured in the following manner. FIG. 2 typically shows an impurity detecting step and a marking step in a process for manufacturing the alkaline secondary battery 100 (an electrode substrate 150).

The long-shaped electrode substrate 150 with foamed Ni as a core member is first prepared (see FIG. 2). A metal impurity particle composed of a metal to be dissolved at a positive electrode potential and deposited at a negative electrode potential, might exist in the electrode substrate 150 placed in this state. The metal impurity particle is considered to be originally contained in the material (Ni) for the core member and adhered to the core member as dust in the manufacturing process. There is a possibility that when the metal impurity particle, particularly, a metal impurity particle composed of Cu excessively exists, it is dissolved at each positive electrode plate 121 with the elapse of time and move in the electrolytic solution, and further it is deposited/grown on each negative electrode plate 123, whereby a small short circuit will occur between the adjacent electrode plates in the manufactured battery.

Thus, the impurity detecting step for detecting whether the metal impurity particle exists in the electrode substrate 150 is performed. In the present embodiment, the electrode substrate 150 is considered to be an object to be detected or examined, and X-rays are applied to the object to acquire a transmitted image. It is then detected based on the transmitted image whether the metal impurity particle exists in the electrode substrate 150 (see FIG. 2). To be more concretely, a plurality of the long-shaped electrode substrates 150 are prepared (three in the figure) and respectively mounted on wind-off devices 160. The electrode substrates 150 wound off from the wind-off devices 160 are superimposed on one another in the form of plural sheets and examined or inspected simultaneously in plural form. The impurity detecting step needs time as compared with other steps. In the present embodiment, however, the electrode substrates 150 are superimposed on one another in plural-sheet form and the existence of the metal impurity particle is detected simultaneously with respect to the plural sheets of electrode substrates. Correspondingly, the impurity detecting step can therefore be completed in a short period of time, and hence productivity can be enhanced.

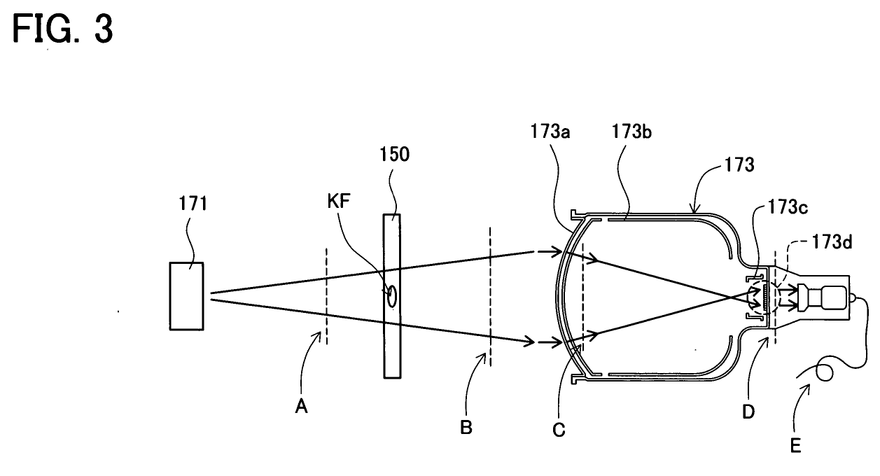

This examination is done using an X-ray fluoroscopic inspection apparatus 170. In the present embodiment, the Toshiba-manufactured X-ray fluoroscopic inspection apparatus TCX-series was used as the X-ray fluoroscopic inspection apparatus 170. The X-ray fluoroscopic inspection apparatus 170 has an X-ray source 171, a color X-ray image intensifier 173 and an image processing apparatus 175. X-rays emitted from the X-ray source 171 are transmitted through the electrode substrate 150 corresponding to an object to be detected or examined, as quantities different according to the material and thickness, followed by entering the color X-ray image intensifier 173. The color X-ray image intensifier 173 converts the incident X-rays into an electron beam, which is further converted into a video signal, followed by being outputted to the outside. The color X-ray image intensifier 173 comprises an input window 173a, a focusing electrode 173b, an anode 173c, a multicolor scintillator 173d, etc. (see FIG. 3). The image processing apparatus 175 displays the video signal outputted from the color X-ray image intensifier 173 as a color image.

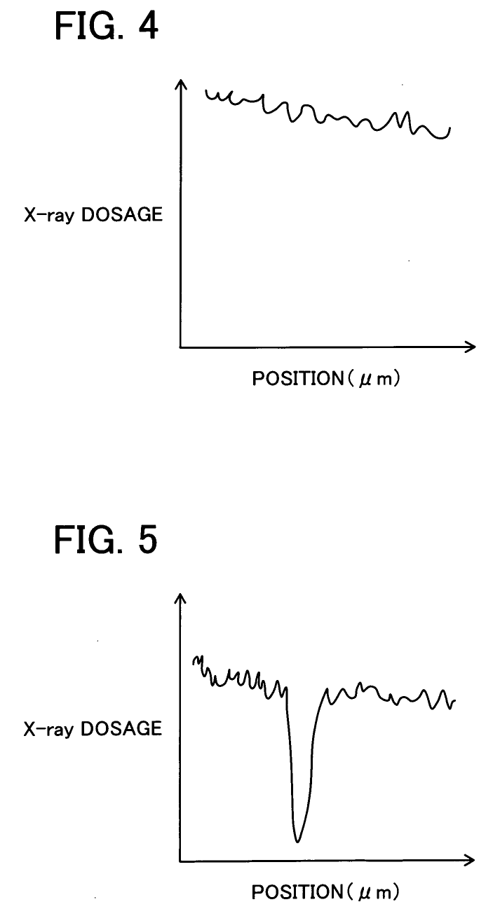

As typically shown in FIG. 3, the X-ray source 171 applies X-rays to the corresponding electrode substrate 150. Such an X-ray dosage as shown in FIG. 4 by a graph is measured at a position indicated by a broken line A in FIG. 3.

The irradiated X-rays pass through the electrode substrate 150. When a metal impurity particle KF exists in the electrode substrate 150, the transmitted amounts of X-rays differ according to a portion comprised of an Ni core member alone and a portion in which the metal impurity particle KF exists. Therefore, an X-ray dosage having a peak corresponding to the portion in which the metal impurity particle KF exists, is measured at a position indicated by a broken line B in FIG. 3 as shown in FIG. 5 by a graph.

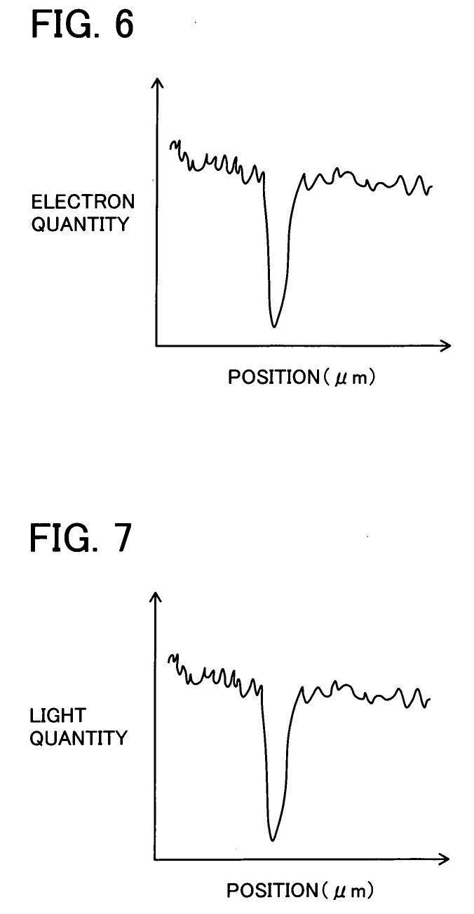

Thereafter, the transmitted X-rays enter the color X-ray image intensifier 173 through the input window 173a thereof. The X-rays having entered the color X-ray image intensifier 173 are converted therein to an electron beam. Therefore, electron quantity having a peak corresponding to the portion in which the metal impurity particle KF exists, is measured at a position indicated by a broken line C in FIG. 3 as shown in FIG. 6 by a graph.

Electron beams are gathered by the anode 173c and transmitted through the multicolor scintillator 173d. At this time, the electron beams are converted to visible light by the multicolor scintillator 173d. Therefore, light quantity having a peak corresponding to the portion in which the metal impurity particle KF exists, is measured at a position indicated by a broken line D in FIG. 3 as shown in FIG. 7 by a graph.

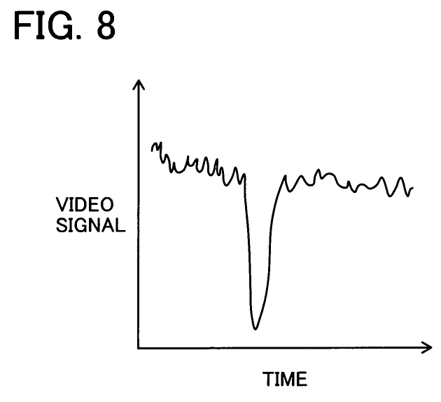

Thereafter, the visible light is outputted as a video signal. Therefore, a video signal having a peak corresponding to the portion in which the metal impurity particle KF exists, is measured at a portion designated at E in FIG. 3 as shown in FIG. 8 by a graph.

Next, the video signal outputted from the color X-ray image intensifier 173 is processed by the image processing apparatus 175, where it is displayed as a color image. Consequently, an examiner is able to confirm through the color image whether the metal impurity particle KF exists. Further, the presence or absence of the metal impurity particle KF is determined by converting signal strength into numerical form. Thus, since it becomes easy to determine whether the metal impurity particle KF exists, the time necessary for the impurity detecting step can be shortened and productivity can also be enhanced.

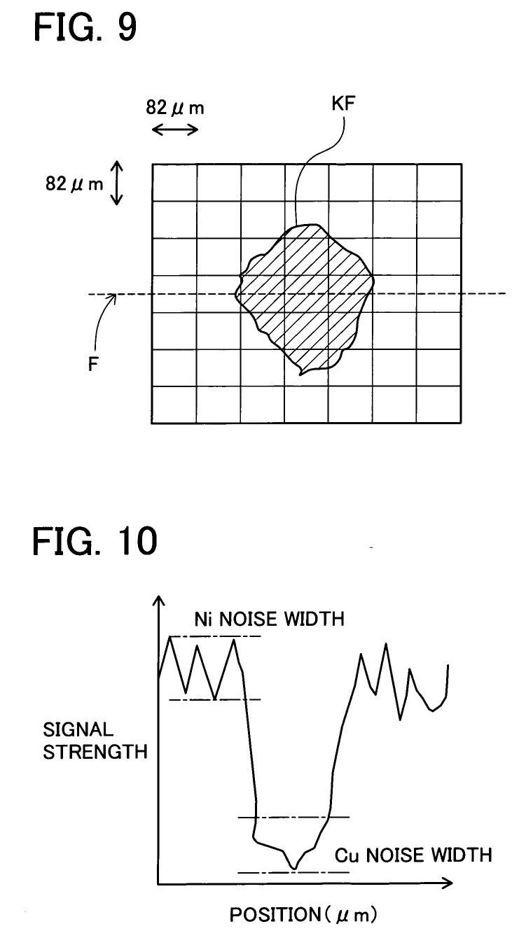

The relationship between the size of the metal impurity particle KF and the signal strength will now be explained with reference to FIGS. 9 through 14. A description will be made here of the case in which the metal impurity particle KF consists of Cu.

FIG. 9 shows the manner in which a metal impurity particle KF having a particle diameter of about 250 μm exists in an electrode substrate 150 corresponding to an object to be detected or examined. When the metal impurity particle KF relatively large to this degree exists, Cu ions dissolved at a positive electrode potential are diffused into each separator and get onto the nearby negative-electrode surface in a high concentration state when the alkaline secondary battery 100 is constructed. Thus, there is a possibility that Cu is easily deposited at a negative electrode potential, so that a short circuit will be brought about. However, the metal impurity particle KF as large as this is measured in such signal strength as shown in FIG. 10 by a graph. Since an Ni noise width and a Cu noise width are definitely separated from each other because the metal impurity particle KF is large, it is possible to easily determine that the metal impurity particle KF exists. Thus, the use of the electrode substrate 150 excluding such a portion makes it possible to prevent the occurrence of a short circuit in the alkaline secondary battery 100 before it happens.

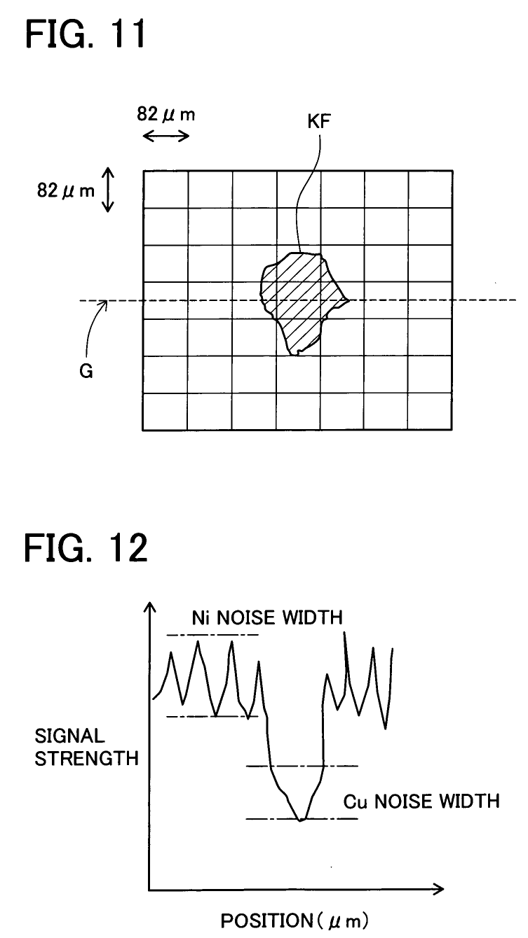

FIG. 11 shows the manner in which a metal impurity particle KF having a particle diameter of about 150 μm exists in an electrode substrate 150 corresponding to an object to be examined. Even when the metal impurity particle KF as large as this exists, Cu ions dissolved at a positive electrode potential are diffused into each separator and get onto the nearby negative-electrode surface in a high concentration state. Thus, there is a possibility that Cu is easily deposited at a negative electrode potential, so that a short circuit will be brought about. However, the metal impurity particle KF of such a size is measured in such signal strength as shown in FIG. 12 by a graph. Since an Ni noise width and a Cu noise width are definitely separated from each other to some degree because the metal impurity particle KF is relatively large, it is possible to easily determine that the metal impurity particle KF exists. Thus, even in this case, the use of the electrode substrate 150 excluding such a portion makes it possible to prevent the occurrence of a short circuit in the alkaline secondary battery 100 before it happens.

In the present embodiment as described above, the presence or absence of the metal impurity particle KF whose particle diameter is 150 μm or more can be detected. It is therefore possible to reliably eliminate an electrode substrate 150 having high danger of causing a short circuit.

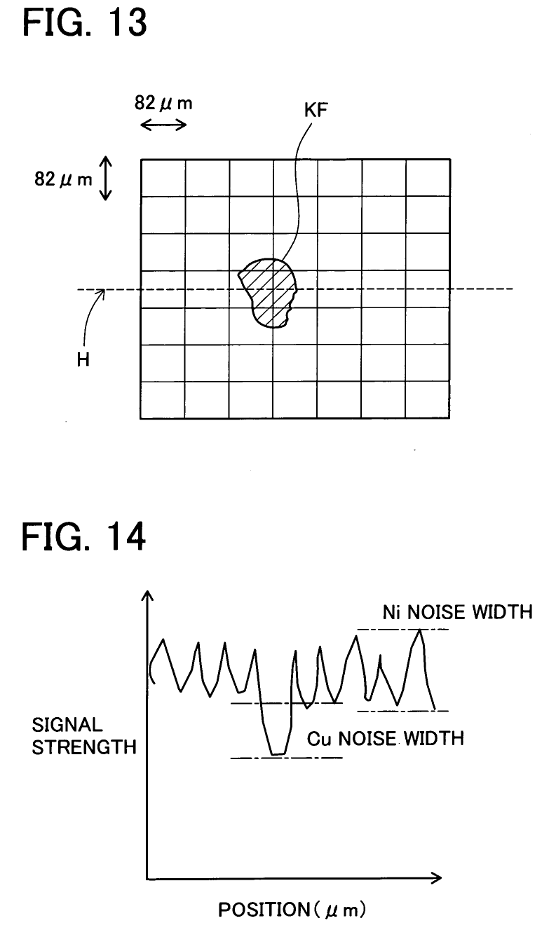

FIG. 13 shows the manner in which a metal impurity particle KF having a particle diameter of about 100 μm exists in an electrode substrate 150 corresponding to an object to be examined. When the metal impurity particle KF relatively small to this degree exists and the alkaline secondary battery 100 is constructed, Cu is little deposited at a negative electrode potential because the concentration of each Cu ion on the nearby negative-electrode surface is low, even though Cu ions dissolved at a positive electrode potential are diffused into each separator. As a result, there is little possibility that a short circuit will be brought about. Incidentally, when the metal impurity particle KF is small, it is measured in such signal strength as shown in FIG. 14 by a graph. Since the metal impurity particle KF is excessively small, an Ni noise width and a Cu noise width partly overlap each other. Hence the presence or absence of the metal impurity particle KF might not be determined definitely.

When the existence of the metal impurity particle KF is confirmed in the impurity detecting step described above, a marking indicative of its particle-existing portion is placed on the corresponding electrode substrate 150 in the next marking step (see FIG. 2). In the present embodiment, a punched hole is punched in the neighborhood of the particle-existing portion by a punching apparatus 180 to perform marking. At this time, punched holes are formed in all of plural sheets of electrode substrates to be inspected. Thus, the electrode substrates 150 each free of the existence of the metal impurity particle KF are also marked. Owing to the execution of such marking step, the corresponding portion of each electrode substrate 150 can easily be discriminated based on the marking even in subsequent steps. The corresponding portion can be eliminated in the most convenient step in terms of production.

Next, a positive active substance layer containing nickel hydroxide is formed in the electrode substrate 150 according to a well known method. For instance, active substance paste obtained by suitably mixing a conductive agent, a bonding agent, a dispersing agent, etc. into a positive active substance is prepared. Then, the active substance paste is applied to the electrode substrate 150 by a predetermined amount. Thereafter, if each electrode substrate 150 to which the active substance paste is applied, is roll-pressed using a pressure roll, the corresponding electrode substrate 150 having the positive active substance layer can be obtained.

Next, the electrode substrate 150 formed with the positive active substance layer is cut into predetermined shapes to fabricate positive electrode plates 121. When one marked in the above marking step exists in the positive electrode plates 121, it is eliminated as a defective part. Incidentally, since the simultaneously-inspected plural sheets of electrode substrates are all marked in the marking step, the positive electrode plates 121 having the markings are eliminated together even if no metal impurity particle KF exists.

When the existence of the metal impurity particle KF is confirmed in the impurity detecting step, it may be feasible to determine in which one of the simultaneously-examined plural electrode substrates 150 the metal impurity particle KF exists. Since, however, the reexamination for each sheet in addition to it needs a considerable time, it is undesirable in terms of production efficiency. On the other hand, the rate of existence of the metal impurity particle KF is not so much. Thus, in the present embodiment, ones formed with punched holes (markings) are all eliminated as defective parts at the step of fabrication of the positive electrode plates 121 without confirming in which any one of the simultaneously-inspected plural electrode substrates 150 the metal impurity particle KF exists. Accordingly, the manufacturing cost can be reduced as a whole.

On the other hand, negative electrode plates 123 each containing solid metal hydride as a negative constituent material are also fabricated according to a well known method.

Thereafter, power generating elements 120 are fabricated according to the well known method. Positive electrode plates 121 of the power generating elements 120 are joined to their corresponding positive electrode collecting plates 130 by welding, and their negative electrode plates 123 are joined to their corresponding negative electrode collecting plates 140 by welding. Such connected bodies are accommodated into the battery case 110. An external positive terminal 115 and its corresponding positive electrode collecting plate 130 disposed at one end, an external negative terminal 117 and its corresponding negative electrode collecting plate 140 disposed at the other end, and the positive electrode collecting plates 130 and the negative electrode collecting plates 140 other than those are respectively joined by welding. Thereafter, an electrolytic solution is injected into the battery case 110, and thereafter a safety valve 113 is mounted so as to close its injection port, thus resulting in the completion of the alkaline secondary battery 100.

In the present embodiment as described above, the impurity detecting step is performed with respect to each electrode substrate 150. It is therefore possible to confirm the metal impurity particle KF that has existed in the electrode substrate 150 and easily eliminate the defective part. Thus, an alkaline secondary battery 100 hard to cause a short circuit and having high reliability can be manufactured. Since this step is performed in the process of manufacturing the alkaline secondary battery 100, defective parts can be eliminated at a stage prior to the construction of the alkaline secondary battery 100, and its manufacturing cost can be reduced.

While the present invention has been explained in line with the embodiment above, the present invention is not limited to the embodiment referred to above. It is needless to say that the present invention is suitably changed and applicable within the scope not departing from the gist thereof.

Although the above embodiment has illustrated by way of example, the alkaline secondary battery as the nickel hydride battery, for example, the present invention may be applied to other batteries such as a nickel-cadmium battery, etc.

Although the above embodiment has illustrated by way of example, the rectangular battery, the present invention may be applied to a cylindrical battery.

Although the impurity detecting step is performed with respect to each electrode substrate 150 prior to the formation of the positive active substance layer, it may be performed with respect to each electrode substrate 150 subsequent to the formation of the positive active substance layer. The impurity detecting step may be effected on the positive electrode plates 121 obtained by cutting the electrode substrate 150.

What is claimed is:

1. A method for manufacturing a battery having a positive electrode plate having a predetermined shape, formed from an electrode substrate, comprising:
an impurity detecting step for applying X-rays onto the electrode substrate or the positive electrode plate corresponding to an object to be examined to acquire a transmitted image, and detecting based on the transmitted image whether a metal impurity particle comprising a metal to be dissolved at a positive electrode potential and deposited at a negative electrode potential exists in the object.

2. The method according to claim 1, wherein the impurity detecting step is performed using an X-ray fluoroscopic inspection apparatus capable of detecting the presence or absence of the metal impurity particle whose particle diameter is 150 μm or more.

3. The method according to claim 1, wherein the impurity detecting step displays the transmitted image as a color image by using an X-ray fluoroscopic inspection apparatus having a color X-ray image intensifier and detects the presence or absence of the metal impurity particle.

4. The method according to claim 1, wherein
the impurity detecting step treats the electrode substrate as the object, and
the method further comprises a marking step for, when the existence of the metal impurity particle in the electrode substrate is detected in the impurity detecting step, applying a marking indicative of a particle-existing portion on the electrode substrate.

5. The method according to claim 1, wherein the impurity detecting step superimposes a plurality of the objects on one another and detects the presence or absence of the metal impurity particle simultaneously with respect to the plural sheets of objects.

6. The method according to claim 4, wherein the impurity detecting step superimposes a plurality of the objects on one another and detects the presence or absence of the metal impurity particle simultaneously with respect to the plural sheets of objects.

7. The method according to claim 5, wherein
the impurity detecting step treats the electrode substrate as the object and is performed with a plurality of sheets of the electrode substrates superimposed on one another, and
the method further comprises:
a marking step for, when the existence of the metal impurity particle is detected at any of the electrode substrates superimposed on one another in the plural sheets in the impurity detecting step, applying a marking indicative of a particle-existing portion on at least any of the electrode substrates; and
an eliminating step for eliminating the corresponding portions with respect to the plurality of sheets of electrode substrates based on the marking without confirming in which of the plurality of superimposed electrode substrates the metal impurity particle exists.

8. The method according to claim 6, wherein
the impurity detecting step treats the electrode substrate as the object and is performed with a plurality of sheets of the electrode substrates superimposed on one another, and
the method further comprises:
a marking step for, when the existence of the metal impurity particle is detected at any of the electrode substrates superimposed on one another in the plural sheets in the impurity detecting step, applying a marking indicative of a particle-existing portion on at least any of the electrode substrates; and
an eliminating step for eliminating the corresponding portions with respect to the plurality of sheets of electrode substrates based on the marking without confirming in which of the plurality of superimposed electrode substrates the metal impurity particle exists.

9. A method for manufacturing an electrode substrate to be used as a positive electrode plate of a battery, comprising:
an impurity detecting step for applying X-rays onto the electrode substrate to acquire a transmitted image and detecting based on the transmitted image whether a metal impurity particle comprised of a metal to be dissolved at a positive electrode potential and deposited at a negative electrode potential when the battery is constructed, exists in the electrode substrate.

10. The method according to claim 9, wherein the impurity detecting step is performed using an X-ray fluoroscopic inspection apparatus capable of detecting the presence or absence of the metal impurity particle whose particle diameter is 150 μm or more.

11. The method according to claim 9, wherein the impurity detecting step displays the transmitted image as a color image by using an X-ray fluoroscopic inspection apparatus having a color X-ray image intensifier and detects the presence or absence of the metal impurity particle.

12. The method according to claim 9, wherein the impurity detecting step superimposes a plurality of sheets of the electrode substrates on one another and detects the presence or absence of the metal impurity particle simultaneously with respect to the plural sheets of electrode substrates.

13. The method according to claim 9, further comprising a marking step for, when the existence of the metal impurity particle in the electrode substrate is detected in the impurity detecting step, applying a marking indicative of a particle-existing portion on the electrode substrate.

14. The method according to claim 12, further comprising a marking step for, when the existence of the metal impurity particle in the electrode substrate is detected in the impurity detecting step, applying a marking indicative of a particle-existing portion on at least any of the electrode substrates.
